(19) United States
(12) Patent Application Publication
(10) Pub. No.: US 2019/0330065 A1
(43) Pub. Date: Oct. 31, 2019

(54) GRAPHITE COMPOSITE CONDUCTIVE BAR MATERIAL AND METHOD FOR PRODUCING GRAPHENE USING THE SAME

(71) Applicant: National Chiao Tung University, Hsinchu City (TW)

(72) Inventors: Kung-Hwa WEI, Taipei City (TW); Po-Jen YEN, Kaohsiung City (TW)

(21) Appl. No.: 16/150,704

(22) Filed: Oct. 3, 2018

(30) Foreign Application Priority Data
Apr. 26, 2018 (TW) 107114264

(51) Int. Cl. C01B 32/19; C25B 1/00; C01B 32/225

(52) U.S. Cl. CPC C01B 32/19; B82Y 30/00; C01B 32/225; C25B 1/00

(57) ABSTRACT

A graphite composite conductive bar material and a method for producing graphene using the same are provided. The graphite composite conductive bar material is fabricated via mixing graphite powder more than 50% by weight with a polymeric material. The graphite composite conductive bar is used in a plasma electrochemical exfoliation process as a cathode and contacts with the surface of the electrolytic solution, whereby the bar material is exfoliated to obtain a less defective graphene. Therefore, the present invention can improve product yield and reduce production cost. In addition, a solid-state nitrogen-containing precursor may be added to the graphite composite conductive bar material for producing nitrogen-doped graphene. In the nitrogen-doped graphene produced by the present invention, the amount of doped nitrogen is increased and tunable compared to the former invention, and the level of oxidization is decreased.

This application claims priority for Taiwan patent application no. 107114264 filed on Apr. 26, 2018, the content of which is incorporated by reference in its entirety.

### BACKGROUND OF THE INVENTION

### Field of the Invention

The present invention relates to a graphene fabrication technology based on a plasma electrochemical exfoliation method, particularly to a graphite composite conductive bar material used in a plasma electrochemical process as the cathode.

### Description of the Prior Art

Graphene is the two-dimensional carbon nanomaterial, featuring many superior properties, such as a linear spectrum, a high electron mobility, a unique optical characteristic, a high ductility, a high toughness, and a single atom layer thickness. Therefore, graphene is regarded as a nanomaterial able to bring about breakthroughs in fields of optoelectronics, energy, chemical materials, etc.

At present, some plasma electrochemical exfoliation-based graphene fabrication methods are being developed, such as the patent TW 1516640 filed by the Inventors. In TW 1516640, graphite is used as cathode; a plasma electrochemical reaction of the graphite electrode takes place in the electrolytic solution to exfoliate the graphite electrode and generate graphene. The plasma electrochemical process can generate graphene under the ambient condition within a very short interval of time. Thus, the plasma electrochemical technology has advantages of simplicity and low cost. Besides, a very slight oxidation is achieved in the plasma electrochemical process via controlling current and voltage. Therefore, graphene obtained from the plasma electrochemical technology contains a low level of oxidation.

A nitrogen-doped graphene has higher carrier density, electric conductivity and stability. Further, doping nitrogen into the surface of graphene may increase absorptivity of graphene to metal ions and enhance the reactivity of graphene in capacitors. In general, oxidized graphene is used as the material to fabricate nitrogen-doped graphene, wherein the oxidized graphene and a nitrogen-containing precursor (in a solid, liquid or gas state) are mixed in a hydrothermal method operated under at least 120° C. and 12 hours to undergo doping and reduction simultaneously; or in a chemical method but a further reduction process is required. Therefore, the ordinary nitrogen doping technology is complicated in processes and expensive in apparatuses. Further, the ordinary nitrogen doping technology requires high temperature and high pressure or even involves usage of poisonous materials, such as hydrazine. On the other hand, the electrochemistry-based nitrogen-doped graphene fabrication methods include the traditional electrochemical method, and the high voltage pulse plasma electrochemical method. The high voltage pulse plasma electrochemical method is relatively dangerous because it must use a voltage of over 1000V. Besides, the high voltage pulse plasma electrochemical method has a lower yield. The traditional electrochemical method uses a graphite electrode as the anode, exfoliating the graphite from the anode and generating nitrogen-doped graphene simultaneously. The traditional electrochemical method is defective in having a higher oxidization level.

The inventors proposed a nitrogen-doped graphene fabrication method (patent TW 201741237), wherein a graphite electrode is used as the cathode; a nitrogen-containing electrolyte is added to the electrolytic solution, whereby a nitrogen-doped graphene is generated through a plasma electrochemical reaction. Similar to the prior art TW 1516640, the prior art TW 201741237 is also based on the plasma electrochemical technology and has advantages of low cost, easy fabrication and high efficiency.

However, in the plasma electrochemical reactions of the prior arts TW 1516640 and TW 201741237, temperature difference-induced thermal stress is likely to cause the generated graphene or nitrogen-doped graphene to have more defects. For the doping process in TW 201741237, the nitrogen-containing material, which is used to dope nitrogen, is added to the electrolytic solution, and the cathode, which is to be exfoliated, only slightly contacts the electrolytic solution. Thus, the process in TW 201741237 resulted in a small concentration nitrogen-doped graphene, only containing less than 1 atomic percent. Also, the voltage and current are used within 40-100V and 0.1-2 A, respectively, leading to the power consumption within 4-200 W. That is, such high power consumption can only result in a low nitrogen-doping level. Besides, the amount of doped nitrogen is unlikely to be adjusted in TW 201741237.

### SUMMARY OF THE INVENTION

The primary objective of the present invention is to provide a graphite composite conductive bar material and a method for producing graphene using the same, wherein graphite powders and a polymeric material are mixed to fabricate a graphite composite conductive bar material, and wherein the graphite composite conductive bar material is used as a cathode in a plasma electrochemical process to produce less defective graphene, whereby is improved the yield of products and decreased the cost of production.

Another objective of the present invention is to provide a graphite composite conductive bar material, for example, a solid-state nitrogen-containing precursor is added to graphite powder along with other binders to form graphite composite conductive bars, and a method for producing doped graphene using the same. The composite bar then undergoes surface plasma induce exfoliation and doping simultaneously for fabricating nitrogen-doped graphene, whereby the amount of nitrogen doped in the nitrogen-doped graphene can be much higher than that in the previous case TW 201741237, and easy to modify, and whereby the oxidization level of the nitrogen-doped graphene is lowered as compared to that in the prior art TW 201741237, where the contact area between graphite and nitrogen-containing sources is relatively small.

In order to achieve the abovementioned objectives, the present invention proposes a graphite composite conductive bar material, wherein a plurality of graphite powders and a polymeric material are mixed and molded to form the graphite composite conductive bar material, that function as cathodes in a plasma electrochemical process for producing exfoliated graphene. The graphite composite conductive bar material contains over 50 wt % graphite powders.

In one embodiment, the graphite composite conductive bar material contains 50-85 wt % graphite powders and 15-50 wt % polymeric material.

In one embodiment, the graphite composite conductive bar material contains a solid-state nitrogen-containing precursor.

In one embodiment, the graphite composite conductive bar material contains less than 35 wt % solid-state nitrogen-containing precursor. The present invention also proposes a method for using the graphite composite conductive bar material to produce graphene, which comprises steps: providing the abovementioned graphite composite conductive bar material; providing a plasma electrochemical apparatus, which includes an electrolytic solution, an anode and a cathode, wherein the graphite composite conductive bar material is used as the cathode, and one end of the graphite composite conductive bar material contacts the electrolytic solution; applying an electric potential difference between the anode and the graphite composite conductive bar material to enable a plasma electrochemical reaction in the surface where the graphite composite conductive bar material contacts the electrolytic solution so as to generate graphene.

In one embodiment, the produced graphene is 1 μm in size and has 1-6 layers of carbon atoms.

In one embodiment, the produced graphene is a nitrogen-doped graphene, and the concentration of nitrogen in the nitrogen-doped graphene is 1-4.6 atomic percent.

In comparison with the conventional technologies that also use a graphite electrode as the cathode in a plasma electrochemical reaction, the graphite composite conductive bar material and the method for producing graphene using the same of the present invention overcomes the problem of temperature difference-induced thermal stress and produces a less defective graphene or a less defective nitrogen-doped graphene. Further, the nitrogen-doped graphene produced by the present invention is higher in the amount of doped nitrogen and lower in the level of oxidization. Furthermore, the present invention can adjust the amount of doped nitrogen via modifying the amount of the nitrogen-containing components in the graphite composite conductive bar material.

Below, embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing a plasma electrochemical apparatus used in a method for producing graphene according to one embodiment of the present invention;

FIG. 2 shows full scan XPS spectra for nanosheets of graphene doped with different amounts of nitrogen in different embodiments of the present invention;

FIG. 3 and FIG. 4 respectively show STEM images and carbon, oxygen and nitrogen analysis of nanosheets of graphene doped with different amounts of nitrogen in different embodiments of the present invention.

### DETAILED DESCRIPTION OF THE INVENTION

The graphite composite conductive bar material disclosed by the present invention is fabricated via mixing a plurality of graphite powders and a polymeric material to form a mixture and molding the mixture. The graphite composite conductive bar material contains over 50 wt % graphite powders. It is preferred: the graphite composite conductive bar material contains 50-85 wt % graphite powders and 15-50 wt % polymeric material.

Further, a solid-state nitrogen-containing precursor may be added to the graphite composite conductive bar material of the present invention, wherein the sum of the concentrations of the solid-state nitrogen-containing precursor and the polymeric material is less than 50 wt %. It is preferred: the graphite composite conductive bar material disclosed by the present invention contains less than 35 wt % solid-state nitrogen-containing precursor.

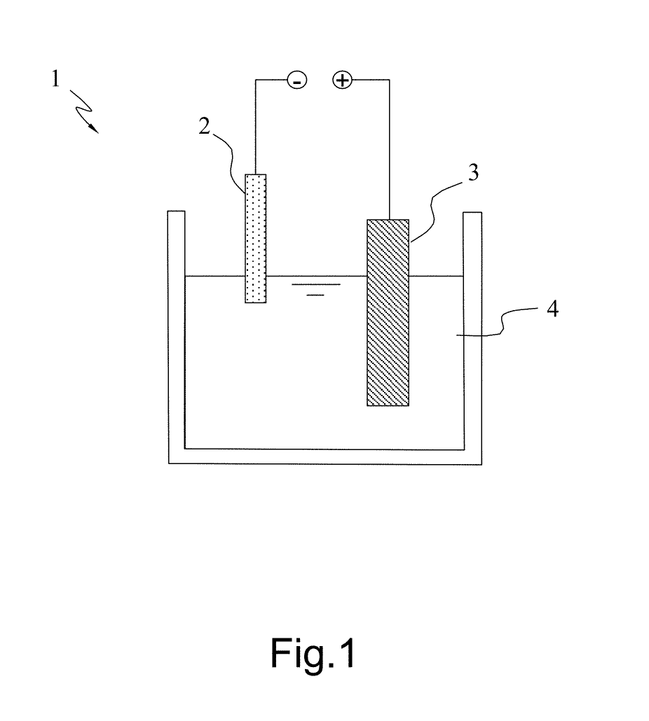

In one embodiment, the polymeric material is poly(methyl methacrylate) (PMMA); the solid-state nitrogen-containing precursor is a solid-state nitrogen-containing material, such as melamine or polyaniline. According to one embodiment, the steps of the method for producing graphene of the present invention are described as follows. Firstly, provide the graphite composite conductive bar material disclosed by the present invention. Next, provide a plasma electrochemical apparatus. Refer to FIG. 1 a diagram schematically showing a plasma electrochemical apparatus 1 for producing graphene. The plasma electrochemical apparatus 1 includes a cathode 2, an anode 3, and an electrolytic solution 4, wherein the graphite composite conductive bar material is used as the cathode 2, and one end of the graphite composite conductive bar material slightly contacts the electrolytic solution 4. As shown in FIG. 1, the upper end of the graphite composite conductive bar material functioning as the cathode 2 is higher than the surface of the electrolytic solution 4; the anode 3 is completely immersed in the electrolytic solution 4. Then, apply an electric potential difference between the anode 3 and the graphite composite conductive bar material functioning as the cathode 2 to make a plasma electrochemical reaction occur in the surface where the graphite composite conductive bar material contacts the electrolytic solution 4. Thus, the graphite composite conductive bar material is exfoliated. The exfoliated product is flushed, centrifugally processed and dried to obtain graphene having a 1-6 layers of carbon atoms.

In principle, the present invention does not particularly limit the material of the anode 3. It is preferred: the anode 3 is made of a conductive inert metal. It is preferred: the electrolytic solution 4 is a strong acid or a strong base, whereby to facilitate the reaction of the graphite composite conductive bar material. It is one of the conditions to generate plasma: the contact area of the anode 3 and the electrolytic solution 4 must be larger than the contact area of the cathode 2 and the electrolytic solution 4. It is preferred: the contact area of the anode 3 and the electrolytic solution 4 is over 20 times larger than the contact area of the cathode 2 and the electrolytic solution 4. It is also preferred: the applied electric potential difference is over 60V and the applied current is within 0.05-0.1 A, whereby the graphite composite conductive bar material is exfoliated.

In one embodiment, the method for producing graphene of the present invention produces non-doped graphene or graphene doped with different concentrations of nitrogen via using a plasma electrochemical reaction and adjusting the concentration of nitrogen in the graphite composite conductive bar material (the ratio of the nitrogen-containing precursor). The non-doped graphene or nitrogen-doped graphene, which is produced by the method of the present invention, is about 1 μm in size and has 1-6 layers of carbon atoms. The concentration of nitrogen in the nitrogen-doped graphene is 1-4.6 atomic percent.

Below, several embodiments are described in detail to introduce the composition and fabrication method of the graphite composite conductive bar material of the present invention and explain how to use the graphite composite conductive bar material of the present invention to produce graphene.

### I. Fabrication of Non-Doped Graphene

An acetone mixing method is used to fabricate graphite powders and poly(methyl methacrylate) (PMMA) into a rectangular graphite composite conductive bar material. Firstly, dissolve poly(methyl methacrylate) (PMMA) in acetone to form a solution. After PMMA is fully dissolved, add an appropriate amount of graphite powders into the solution to form a mixture, and agitate the mixture for 1 hour. Then, pour the mixture into a mold whose capacity is 10 mm in length, 30 mm in width, and 2-10 mm in thickness. Keep the mixture still in the mold at an ambient temperature. After acetone is volatilized, a graphite composite conductive bar material is acquired.

A plasma electrochemical method is used to exfoliate the graphite composite conductive bar material and obtain nanosheets of non-doped graphene. The plasma electrochemical method uses the produced graphite composite conductive bar material as the cathode and lets the cathode slightly contact the electrolytic solution. The plasma electrochemical method uses a platinum plate (3×15 cm²) as the anode and immerses the anode into the electrolytic solution. The electrolytic solution is a 2M sodium hydroxide solution. After the abovementioned apparatus is established, apply a voltage of 60V between the cathode and anode and the applied current is within 0.05-0.1 A. After the exfoliation of the graphite composite conductive bar material is completed, separate the product from the electrolytic solution in a vacuum filtering method, rinse the separated product to achieve a neutral state, and dry the product at a temperature of 70° C. Thus, the powder-form of non-doped graphene is obtained.

### II. Fabrication of Nitrogen-Doped Graphene

An acetone mixing method is used to fabricate different weight ratios of graphite powders/poly(methyl methacrylate) (PMMA) and appropriate amounts of melamine into rectangular graphite composite conductive bar materials. The weight of PMMA plus melamine does not exceed 50% of the total weight of the graphite composite conductive bar material. Firstly, dissolve poly(methyl methacrylate) (PMMA) in acetone to form a solution. After PMMA is fully dissolved, add graphite powders and melamine into the solution to form a mixture, and agitate the mixture for 1 hour. Then, pour the mixture into a mold whose capacity is 10 mm in length, 30 mm in width, and 2-10 mm in thickness. Keep the mixture still in the mold at an ambient temperature. After acetone is volatilized, a graphite composite conductive bar material containing nitrogen is acquired.

A plasma electrochemical method is used to exfoliate the graphite composite conductive bar material containing nitrogen and obtain nanosheets of nitrogen-doped graphene. The plasma electrochemical method uses the produced graphite composite conductive bar material containing nitrogen as the cathode and lets the cathode slightly contact the electrolytic solution. The plasma electrochemical method uses a platinum plate (3×15 cm²) as the anode and immerses the anode into the electrolytic solution. The electrolytic solution is a 2M sodium hydroxide solution. After the abovementioned apparatus is established, apply a voltage of 60V between the cathode and anode and the applied current is within 0.05-0.1 A. After the exfoliation of the graphite composite conductive bar material containing nitrogen is completed, separate the product from the electrolytic solution in a vacuum filtering method, rinse the separated product to achieve a neutral state, and dry the product at a temperature of 70° C. Thus, the powder-form of nitrogen-doped graphene is obtained.

### III. Results of Experiments

1. The proportions of the components of the graphite composite conductive bar materials are shown in Table.1.

TABLE 1

| | Weight percentage of | | |
|---|---|---|---|
| | components of graphite | | |
| | composite conductive bar | | |
| | material (wt %) | | |
| Experimental | Graphite | | |
| group | powder | PMMA | Melamine |
| Embodiment 1 | 70 | 30 | — |
| Embodiment 2 | 70 | 29 | 1 |
| Embodiment 3 | 70 | 27 | 3 |
| Embodiment 4 | 70 | 25 | 5 |
| Embodiment 5 | 70 | 23 | 7 |
| Embodiment 6 | 70 | 21 | 9 |

### 2. X-Ray Photoelectron Spectroscopy (XPS) Inspection

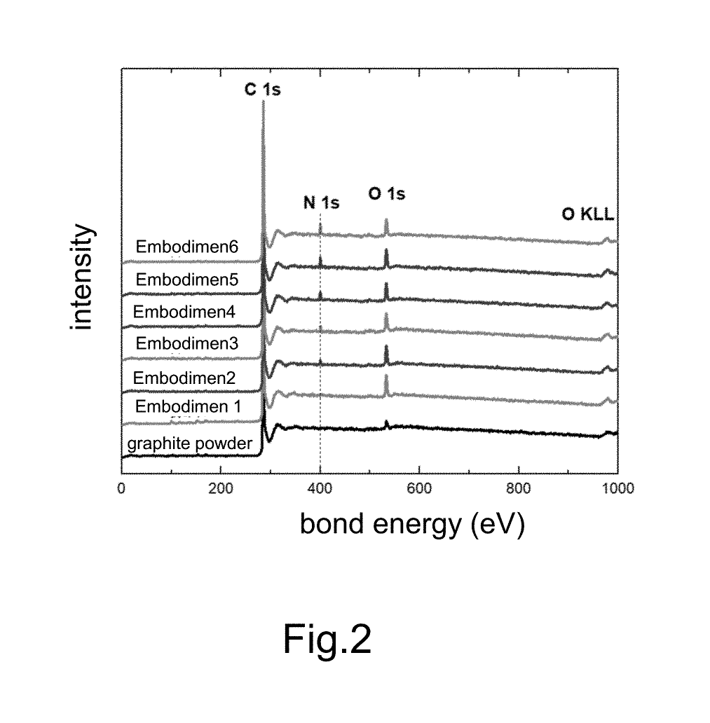

The graphite composite conductive bar materials with different amounts of melamine will generate nanosheets of graphene doped with different amounts of nitrogen. Refer to FIG. 2 showing full scan XPS spectra for nanosheets of graphene doped with different amounts of nitrogen. It is found in FIG. 2: the N1s signal appears in Embodiments 2-6. FIG. 2 indicates that nitrogen is doped into graphene and confirms that the amount of nitrogen doped into graphene is adjustable. The results of XPS experiments of nanosheets of graphene doped with different amounts of nitrogen are shown in Table.2.

TABLE 2

| | Results of | | |
|---|---|---|---|
| | XPS analysis | | |
| | (at %) | | |
| | C | O | N |
| Graphite | 98.3 | 1.7 | — |
| powder | | | |
| Embodiment 1 | 91.5 | 8.5 | — |
| Embodiment 2 | 91.0 | 8.0 | 1.1 |
| Embodiment 3 | 91.2 | 7.5 | 1.2 |
| Embodiment 4 | 91.2 | 6.8 | 2.0 |
| Embodiment 5 | 90.3 | 6.6 | 3.2 |
| Embodiment 6 | 89.5 | 5.9 | 4.6 |

### 3. Scanning Transmission Electron Microscopy (STEM) Inspection

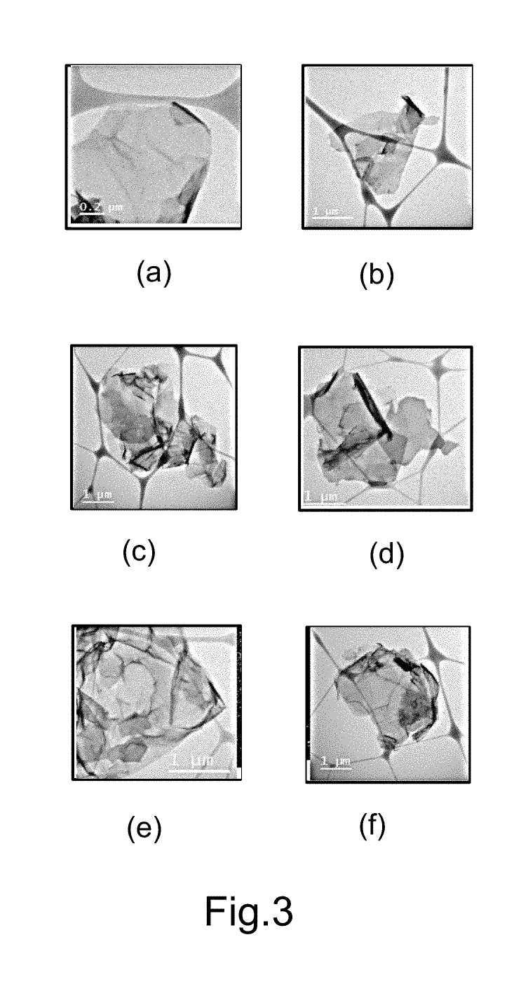

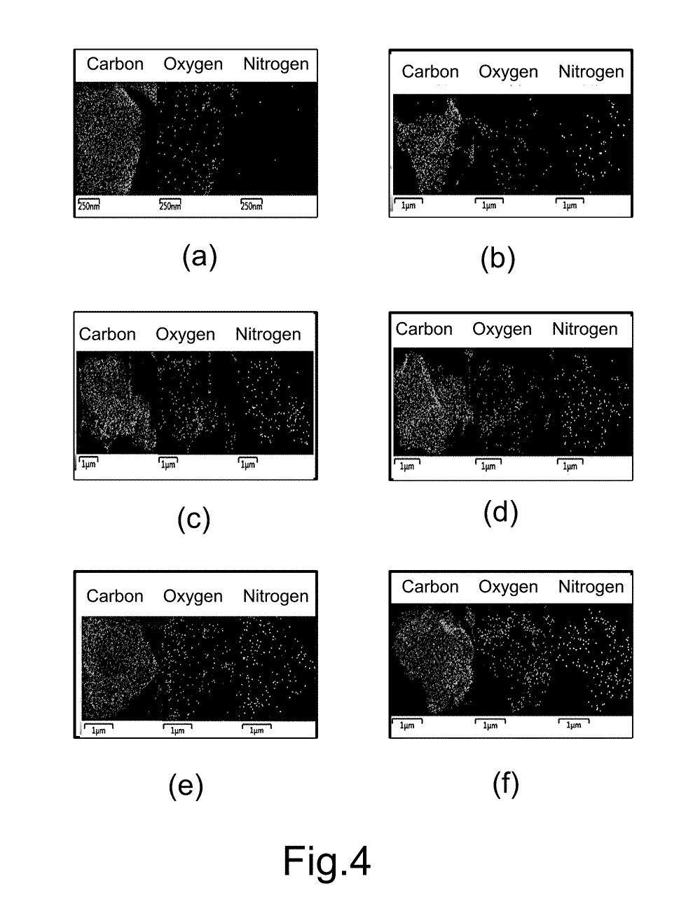

Refer to FIG. 3 and FIG. 4 for the results of STEM experiments of nanosheets of graphene doped with different amounts of nitrogen. FIG. 3 shows the STEM images. FIG. 4 shows the analysis results of carbon, oxygen and nitrogen by STEM. In FIG. 3 and FIG. 4, (a), (b), (c), (d), (e), and (f) are respectively the experimental results of Embodiments 1-6. It is found in FIG. 4: nitrogen atoms are uniformly distributed in the graphene nanosheets of Embodiments 2-6.

In the present invention, a solid-state nitrogen-containing precursor is added to the graphite composite conductive bar material functioning as the cathode. For example, in Embodiments 2-6, both the melamine and the graphite powder are in form of solid-state powder, and the contact area between them is thus greatly increased. Therefore, the nitrogen content of the nitrogen-doped graphene nanosheets is increased. Further, the nitrogen content of the nitrogen-doped graphene nanosheets may be varied with the amount of the added melamine.

In conclusion, the present invention proposes a graphite composite conductive bar material and a method for producing graphene using the same, wherein a mixture of graphite powders and a polymeric material is used to fabricate the graphite composite conductive bar material, and wherein the graphite composite conductive bar material functions as the cathode in a plasma electrochemical process, whereby is overcome the problem of temperature difference-induced thermal stress and acquired a less defective graphene, wherefore is increased the production yield and decreased the fabrication cost. The present invention may further adds a solid-state nitrogen-containing precursor to the graphite composite conductive bar material for producing a nitrogen-doped graphene, whereby the nitrogen doped in the nitrogen-doped graphene of the present invention is 4-5 times the nitrogen doped in the nitrogen-doped graphene produced by the conventional plasma electrochemical process, and whereby the level of oxidization is lowered. Besides, the concentration of nitrogen in the nitrogen-doped graphene can be adjusted simply via modifying the amounts of the nitrogen-containing components of the graphite composite conductive bar material of the present invention.

The amount of nitrogen doped in the nitrogen-doped graphene can be much higher than that in the previous case TW 201741237, and easy to modify, and whereby the oxidization level of the nitrogen-doped graphene is lowered as compared to that in the prior art TW 201741237, where the contact area between graphite and nitrogen-containing sources is relatively small.

The present invention has been described in detail with the embodiments above. However, it should be understood: these embodiments are only to demonstrate the technical contents and characteristics of the present invention but not to limit the scope of the present invention. Any equivalent modification or variation according to the spirit of the present invention is to be also included by the scope of the present invention.

What is claimed is:

1. A graphite composite conductive bar material, functioning as a cathode in a plasma electrochemical process for producing graphene, wherein a plurality of graphite powders and a polymeric material are mixed and molded to form said graphite composite conductive bar material, and wherein said graphite composite conductive bar material contains more than 50 wt % of said graphite powders.

2. The graphite composite conductive bar material according to claim 1, wherein said polymeric material is poly(methyl methacrylate) (PMMA).

3. The graphite composite conductive bar material according to claim 1, wherein a proportion of said graphite powders is 50-85% of a total weight of said graphite composite conductive bar material, and a proportion of said polymeric material is 15-50% of said total weight of said graphite composite conductive bar material.

4. The graphite composite conductive bar material according to claim 3 further comprising a solid-state nitrogen-containing precursor.

5. The graphite composite conductive bar material according to claim 4, wherein said solid-state nitrogen-containing precursor is melamine or polyaniline.

6. The graphite composite conductive bar material according to claim 4, wherein a proportion of said solid-state nitrogen-containing precursor is less than 35% of said total weight of said graphite composite conductive bar material.

7. A method for producing graphene, comprising steps:
providing a graphite composite conductive bar material, wherein a plurality of graphite powders and a polymeric material are mixed and molded to form said graphite composite conductive bar material, and wherein said graphite composite conductive bar material contains more than 50 wt % of said graphite powders;
providing a plasma electrochemical apparatus including an electrolytic solution, an anode and a cathode, wherein said graphite composite conductive bar material is used as said cathode with one end thereof contacting said electrolytic solution; and
applying an electric potential difference between said anode and said graphite composite conductive bar material to make a surface of said graphite composite conductive bar material, which contacts said electrolytic solution, undertake a plasma electrochemical reaction to form graphene.

8. The method for producing graphene according to claim 7, wherein said electrolytic solution is a strong acid or a strong base.

9. The method for producing graphene according to claim 7, wherein said electric potential difference is more than 60V and an applied current is within 0.05-0.1 A.

10. The method for producing graphene according to claim 7, wherein a contact area between said anode and said electrolytic solution is more than 20 times a contact area between said graphite composite conductive bar material and said electrolytic solution.

11. The method for producing graphene according to claim 7, wherein said graphene is 1 μm in size and has 1-6 layers of carbon atoms.

12. The method for producing graphene according to claim 7, wherein said graphene is a nitrogen-doped graphene with 1-4.6 at % doped nitrogen.

13. The method for producing graphene according to claim 7, wherein said anode is made of a conductive inert metal.

14. The method for producing graphene according to claim 7, wherein said polymeric material is poly(methyl methacrylate) (PMMA).

15. The method for producing graphene according to claim 7, wherein a proportion of said graphite powders is 50-85% of a total weight of said graphite composite conductive bar material, and a proportion of said polymeric material is 15-50% of said total weight of said graphite composite conductive bar material.

16. The method for producing graphene according to claim 15, wherein said graphite composite conductive bar material further comprising a solid-state nitrogen-containing precursor.

17. The method for producing graphene according to claim 16, wherein said solid-state nitrogen-containing precursor is melamine or polyaniline.

18. The method for producing graphene according to claim 16, wherein a proportion of said solid-state nitrogen-containing precursor is less than 35% of said total weight of said graphite composite conductive bar material.
